(19) United States
(12) Patent Application Publication
(10) Pub. No.: US 2009/0157730 A1
(43) Pub. Date: Jun. 18, 2009

(54) SYSTEM AND METHOD FOR GENERATING WEB PAGE USED TO SHARE RECORDS

(75) Inventor: ZYH-MING HUANG, Changhua City (TW)

Correspondence Address: ROSENBERG, KLEIN & LEE, 3458 ELLICOTT CENTER DRIVE-SUITE 101, ELLICOTT CITY, MD, 21043, US

(73) Assignee: EVERMORE TECHNOLOGY, INC., HSINCHU (TW)

(21) Appl. No.: 12/026,110

(22) Filed: Feb. 5, 2008

(30) Foreign Application Priority Data
Dec. 14, 2007 (TW) 096147944

(51) Int. Cl. G06F 17/30

(52) U.S. Cl. 707/102; 707/E17.005

(57) ABSTRACT

A method for generating a web page used to share records by a computer system is provided. The first step of the method is to generate a first web page with a map image and display a traveling route thereon. Then, at least one linking tag linking to at least one record file respectively disposed on a creation geographical location thereof is displayed on the map image. Next, the record file is uploaded to a far-end database and the record file has a far-end address. Last, a second web page is generated by copying the first web page and replacing the linking address of the linking tag with the individual far-end address of the record file. The second web page could be sent to friends via the network and opened by a personal computer system for sharing the shared record files stored in the far-end database.

### BACKGROUND OF THE INVENTION

1. Field of the Invention

The present invention is related to a method executed by a computer system, and more particular to a system and method for generating a web page used to share records by a computer system.

2. Description of Related Art

Nowadays, digital cameras are extremely popular. One can take photos to record daily life by a digital camera. The photos are recorded as digital image files. The digital image files could be further shared to friends by e-mails or by a web album. Web album functions provided by image databases may store the digital image files and display the photos for browsing. Image databases for storing and sharing photos are known.

In most image databases, digital image files are organized by date or special topic. These kinds of organization are simple but unexciting. U.S. patent 2007/0233368 discloses a shared image database with geographical navigation. Users could upload digital image files with geographic information to a shared image database. The shared image database will store and display the digital image files by geographical parameters.

However, if there are a plurality of photos located on the same location, users have to assort these photos by other criterion, such as date. Besides, the use of web album function is only permitted when users have passed complicated process for joining a website. It is not convenient for browsing by a web album. Furthermore, the personal photos showing on a website could be copied easily and the disclosed data will endanger individual security. Therefore, it is necessary to provide another mechanism for assisting records sharing.

### SUMMARY OF THE INVENTION

Accordingly, the objective of the present invention is to provide a method and system for generating a web page to share records that can be read by a personal computer system directly and the record files are downloaded according to the selection of the linking tags so as to decrease transmission data volume, enable users to share the records conveniently and rapidly, and protect data security by generating a first web page used to browse records in advance, uploading the record files to a far-end database, and creating a second web page used to share records by copying the first web page and replacing the linking address of each linking tag with the individual far-end storage address of each record file.

In order to achieve the foregoing objective, the present invention provides a method for generating a web page used to share records by a computer system. The method includes the following steps. Firstly, a first web page is generated and a map image is embedded therein. Next, the first web page is controlled to display a traveling route overlaid on the map image in accordance with a GPS data file that includes a plurality of geographical locations varying with a plurality of time parameters during moving along the traveling route. Next, a creation time of at least one record file is compared with the time parameters of the GPS data file so as to obtain a creation geographical location of the record file and at least one linking tag having a linking address linking to the record file is configured overlaid on the map image in accordance with the creation geographical location of the record file. Next, the record file is updated to be stored in a far-end database and is assigned to a far-end storage address. Next, a second web page is created by copying the first web page. Lastly, the second web page is updated by replacing the linking address of the linking tag with the far-end storage address of the record file.

In order to achieve the foregoing objective, the present invention provides a system for generating a web page used to share records by a computer system. The system includes a first analyzing module, a second analyzing module, a comparing module, an interface developing module and a second web page developing module. The first analyzing module analyzes a GPS data file that includes a plurality of geographical locations varying with a plurality of time parameters during moving along a traveling route so as to obtain a time parameter of each of the geographical locations. The second analyzing module analyzes at least one record file so as to obtain a creation time of the record file. The comparing module is coupled to the first analyzing module and the second analyzing module for obtaining a creation geographical location of the record file by comparing a creation time of the record file with the time parameters of the GPS data file. The interface developing module is coupled to the first analyzing module and the comparing module. The interface developing module generates a first web page for displaying the traveling route and configures at least one linking tag having a linking address linking to one of the record file in accordance with the creation geographical location of the record file. The second web page developing module is coupled to the interface developing module. The second web page developing module generates a second web page by copying the first web page and replaces the linking address of the linking tag with a far-end storage address of the record file.

The format of the at least one record file belongs to a digital image file format or a digital audio file format.

The objective of the present invention will no doubt become obvious to those of ordinary skill in the art after reading the following detailed description of the preferred embodiment, which is illustrated in the various figures and drawings.

### BRIEF DESCRIPTION OF THE DRAWINGS

The present invention can be fully understood from the following detailed description and preferred embodiment with reference to the accompanying drawings, in which:

FIG. 1 illustrates a data transmission system among a digital camera, a GPS data recorder and a computer system;

FIG. 2 is a block diagram of a records browsing/sharing system according to the present invention;

FIG. 3A, FIG. 3B and FIG. 4 show illustrative displays of browsing interfaces according to the present invention;

FIG. 5 is a flow chart of a method for generating the first web page used to browse records according to the present invention;

FIG. 6 shows illustrative file content of the first web page and the second web page according to the present invention;

FIG. 7 shows an illustrative display of the records sharing function according to the present invention;

FIG. 8 illustrates a block diagram of a communication system among personal computer terminals and a far-end database;

FIG. 9 is a flow chart of a method for generating the second web page used to share records according to the present invention;

### DETAILED DESCRIPTION OF THE PREFERRED EMBODIMENTS

The objective of the present invention will no doubt become obvious to those of ordinary skill in the art after reading the following detailed description of the preferred embodiment, which is illustrated in the various figures and drawings.

The present invention provides a method and system for generating a web page used to share records by a computer system. By executing an application program, a first web page used to browsing records is generated. The first web page displays one or more linking tags having linking addresses respectively corresponding to one or more record files stored in local database. One can upload the record files to a far-end database for sharing. After uploading the record files, a second web page used to share records will be generated. In the second web page, the linking addresses of the linking tags link to the far-end database. The second web page could be sent to friends for sharing records via the network.

GPS (Global Positioning System) technology could obtain latitude and longitude coordinates, bearing, velocity, and etc, by receiving signals transmitted from artificial satellites to perform mathematical calculations. A GPS data recorder (GPS data logger) is able to create a GPS data file with a specific format to record the geographical locations consisting of latitude and longitude coordinates, bearing, velocity, and etc, varying with time continuously by applying GPS technology. Moving along a traveling route with a GPS data recorder, the GPS data recorder would create a GPS data file recording a plurality of geographical locations at different time parameters. The GPS data file created by the GPS data recorder could be read out by a specific software. The GPS data recorder is a popular device nowadays, so the technology will not be illustrated in detail.

There are two parts in a digital image file. One is used for storing image data, and the other one is used for storing appendixes of this file. When an digital image file is created, a digital camera would write appendixes, such as AE value, shutter period, ISO value, and etc., corresponding to the conditions of photographing into the header of the file with a specific format. For example, the format of JPEG file header is EXIF type.

A user who brings a GPS data recorder and a digital camera in a journey can take photos and record geographical locations at the same time. Then, by analyzing and comparing the creation times of the digital image files with the time parameters of the GPS data file, a corresponding geographical locations of all the files could be obtained. These obtained corresponding geographical locations are the creation geographical locations of these files.

Likely, a digital audio file has an individual start time and an end time of n audio period. Either the start time or the end time could be regard as the creation time of the digital audio file. The creation geographical location of the digital audio file could be obtained by comparing the creation time of the file with the time parameters of the GPS data file.

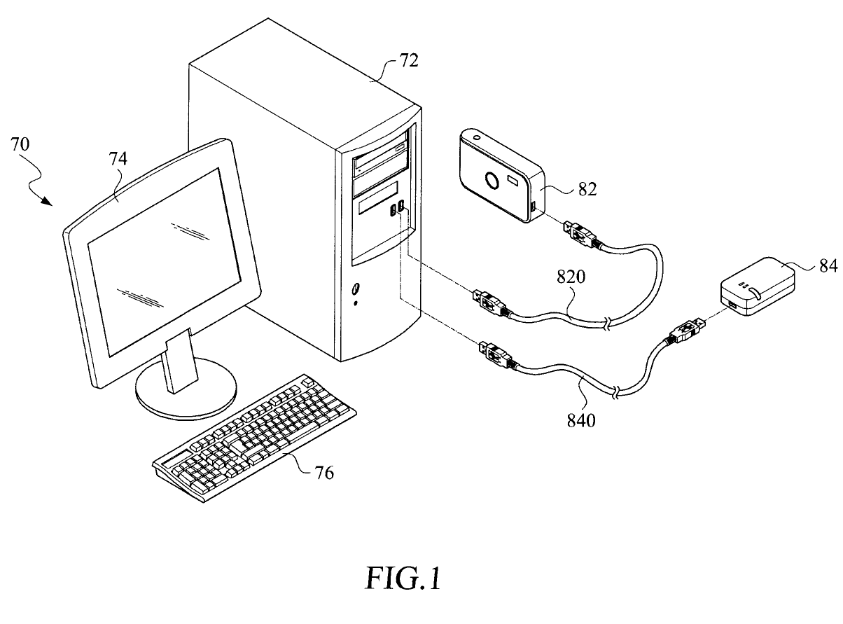

Please refer to FIG. 1 which illustrates a data transmission system among a digital camera, a GPS data recorder and a computer system. A user brought a digital camera 82 and a GPS data recorder 84 for taking photos and recording geographical locations during moving along a traveling route. The GPS data recorder 84 would create a GPS data file which records the geographical locations varying with time continuously during moving along a traveling route. The user took one or more photos while the GPS data file was created. These photos are stored as different digital image files in the digital camera 82. Each digital image file has an individual creation time.

It is noted that the presented method and system for generating a web page used to share records can be implemented by a computer system. The user has to store the GPS data file and the digital image files in the database of a computer system 70. As shown in FIG. 1, a digital camera 82 and a GPS data recorder 84 are respectively connected to the computer system 70 by a transmission wire 820, 840 for transmitting the digital image files and the GPS data file to the database of the computer system 70.

FIG. 1 only shows a rough structure of the computer system 70 for supporting operation illustration. The computer system 70 includes a host 72, a display 74 and a keyboard 76. One killed in the art must realize that the computer system 70 further includes various hardware, such as central processor, memory, peripheral devices, and etc., for installing software, such as an operating system and several application programs, so as to achieve expected computer functions together.

It is noted that FIG. 1 takes a desktop computer to represent the computer system 70 only for an illustrative reason. The computer system 70 can be replaced with a notebook, or other computer types. Besides, the communication among the digital camera 82, the GPS data recorder 84 and the computer system 70 could be replaced with wireless communication or other wired communication. Furthermore, storage media, such as memory cards, can be used to transmit data among the digital camera 82, the GPS data recorder 84 and the computer system 70.

Likely, the digital audio files created by a recording device during the journey could be stored in the database of the computer system 70.

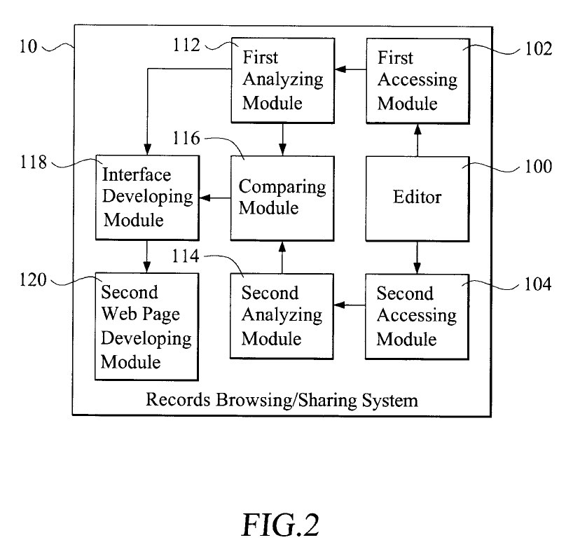

Please refer to FIG. 1 and FIG. 2 together. FIG. 2 illustrates a block diagram of a records browsing/sharing system according to the present invention. As shown in FIG. 2, the records browsing/sharing system 10 includes an editor 100, a first accessing module 102, a second accessing module 104, a first analyzing module 112, a second analyzing module 114, a comparing module 116, an interface developing module 118 and a second web page developing module 120.

The records browsing/sharing system 10 is used to generate a first web page used to browse the record files and a second web page used to share records. The format of the record files belongs to the digital image file format or the digital audio file format. The records browsing/sharing system 10 achieve the expected function by an application program installed in the computer system 70. The application program coding will not be illustrated in detail, because one skilled in the art himself could use any proper program language to develop a proper application program in accordance with the function of each module illustrated hereinafter.

The editor 100 collects necessary information from the data inputted by inputting devices, such as keyboard, mouse, or etc. The GPS data file and the digital image files are stored in a first storage address and a second storage address inside the database of the computer system 70. The first storage address and the second storage address can be inputted by the editor 100. The first accessing module 102 and the second accessing module 104 are coupled to the editor 100 and a database (not shown in FIG. 2) for accessing data in accordance with the commands collected from the data received by the editor 100. According to the commands generated from the editor 100, the first access module 102 would access the GPS data file from the first storage address and he second access module 104 would access the record files from the second storage address.

The first analyzing module 112 is coupled to the first accessing module 102. The first analyzing module 112 analyzes the GPS data file for obtaining all the geographical locations consisting of latitude and longitude coordinates, varying with time. The second analyzing module 114 is coupled to the second accessing module 104. The second analyzing module 114 analyzes the record files for obtaining the creation times of the record files. The comparing module 116 is coupled to the first analyzing module 112 and the second analyzing module 114 for obtaining a creation geographical location of each record file by comparing the creation times of the record files with the time parameters of the GPS data file. That is, the creation time of each record file is regarded as an index for looking for a corresponding geographical location with an individual time parameter equivalent to the creation time in the GPS data file. The obtained corresponding geographical location is the creation geographical location of the record file.

The interface developing module 118 is coupled to the first analyzing module 112, the comparing module 116 and the display engine of the computer system 70 for generating a user interface of the application program and a browsing interface of the record files embedded in the user interface on the display 74.

In one embodiment, after executing the application program, the interface developing module 118 would create a first web page and control the first page to link to a map service website, such as Google Map, Google Earth, or etc., to download a map image. The interface developing module 118 would embed the map image in the first web page, display a traveling route overlaid on the map image in accordance with the analysis of the GPS data file, and further configure a plurality of linking tags respectively having a linking address linking to a specific record file distributed on the creation geographical location overlaid on the map image. It is noted that the first web page could communicate with the map service website, such as Google Map, Google Earth or etc, by some specific commands or functions provided by the application program interface in order to execute the specific procedures, such as overlaying the traveling route and the linking tags on the map image and opening a specific record file according to selection.

Furthermore, the records browsing/sharing system 10 would open a specific file in responsive to the selection by operating inputting devices, such as the keyboard 76, mouse, and etc, of the computer system 70.

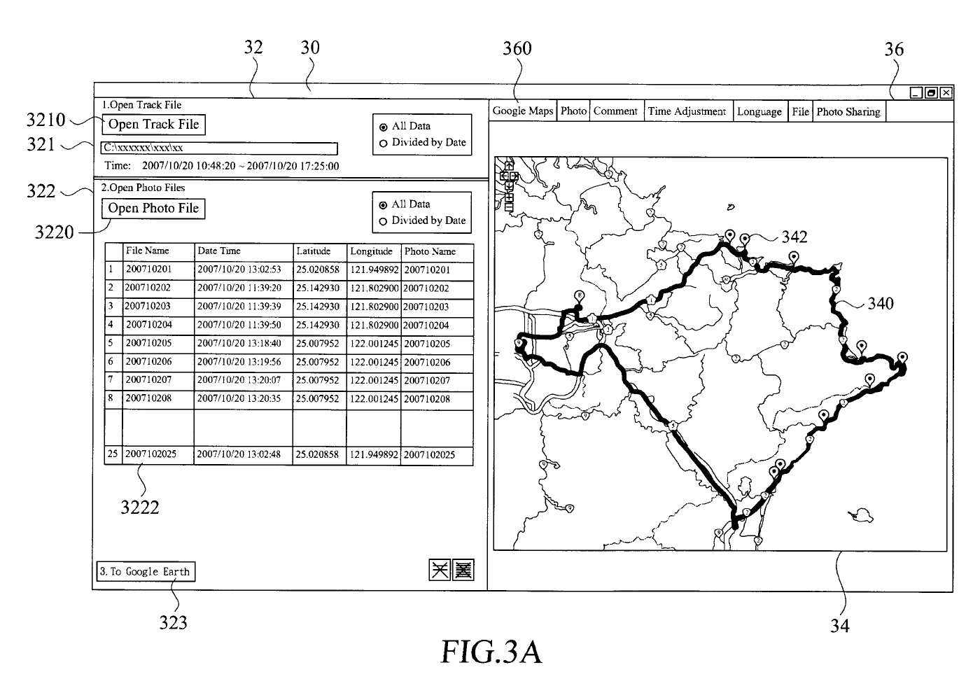

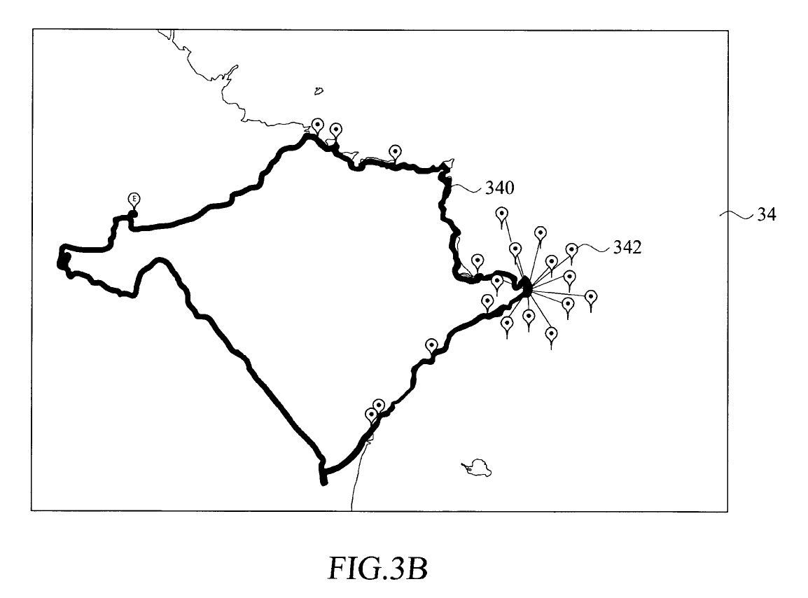

Following, please refer to FIG. 3A, FIG. 3B and FIG. 4 together which show illustrative displays of browsing interfaces according to the present invention. As shown in FIG. 3A, during execution of the application program, a user interface 30 would be spread on the display 74 for communicating with the user. The arrangement of the user interface 302 was set in advance by the application program. In this embodiment, the user interface 30 includes an editing interface 32 and a browsing interface 34. The spread first web page is embedded in the browsing interface 34 for displaying the map image corresponding to the traveling route 340.

The editing interface 32 includes two editing blocks 321, 322. The editing block 321 relates to the access of the GPS data file. The editing block 321 is used to access the GPS data file and an icon 3210 is arranged inside the editing block 321 for opening file management module of the computer system 70. One can input a storage address by selection. Thus, the first accessing module 102 would access the GPS data file from the first storage address. Then, the first analyzing module 112 would analyze the GPS data file to obtain the geographical locations distributed at different time parameters. Following, the interface developing module 11 would control the first web page to display the traveling route 340.

The editing block 322 relates to the access of the record files. An icon 3220 is arranged in the editing block 322 for opening file management module. One can input a storage address by selection. Thus, the second accessing module 104 would access the record files from the second storage address. Then, the second analyzing module 114 would analyze the record files for obtaining the creation times of the record files. Afterwards, the comparing module 116 receives the analyses provided by the first analyzing module 112 and the second analyzing module 114 and compares the creation times of the record files for obtaining the creation geographical location of each record file. Following, the interface developing module 118 would display the linking tags 342 distributed on the creation geographical locations along the traveling route 340. Each linking tag 342 has a linking address linking to a specific record file. Thus, as shown in FIG. 4, a specific record (as shown in Figures, the record is a photo) could be opened by selecting a corresponding linking tag. Furthermore, if one geographical location corresponds to a plurality of record files, clicking this linking tag will spread out all the overlapped linking tags corresponding to the same geographical location, as shown in FIG. 3B.

In the embodiment, a list 3222 is embedded in the user interface 30 for listing the file names, the creation time, the geographical location, including the latitude and the longitude coordinates, of all the record files. The user interface 90 further includes a menu 36 including a plurality of icons 360 that corresponds to a specific function to control the browsing interface 34. The icon 323 links to activate the Google Earth. By clicking the icon 323, the Google Earth would be activated and the traveling route and the linking tags of the record files would be overlaid on the satellite map on Google Earth.

In an embodiment, the user interface 30 further provides a slide function for opening the record files automatically one by one along the traveling route 340. The mentioned slide function could enrich the records browse and make the records browse more interesting.

The present invention organizes the record files by the traveling route. thus, the records brows could be much more interesting and meaningful. Besides, the records browsing/sharing system 10 is implemented by a personal computer that could protect personal data security.

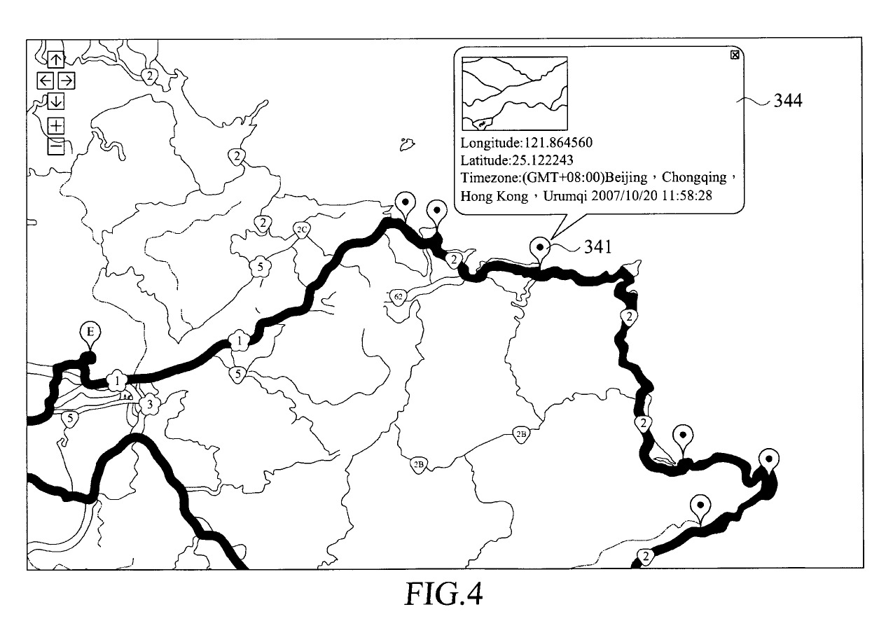

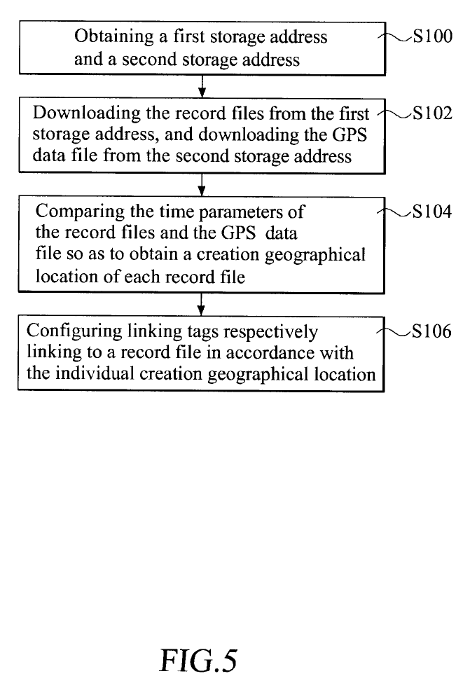

Following, a method for generating the first web page used to browsing records is provided. Please refer to FIG. 5 which is a flow chart of a method for generating the first web page used to browse records according to the present invention. As shown in FIG. 5, the method includes the following steps.

Firstly, S100 is performed. A first storage address and a second storage address are obtained.

Next, S102 is performed. A GPS data file is downloaded from the first storage address and a plurality of record files are downloaded from the second storage address. The GPS data file records the geographical locations varying with time during moving along a traveling route. The record files including individual creation times are created while the GPS data file records the geographical locations.

Next, S104 is performed. The creation times of record files are compared with the GPS data file so as to obtain the corresponding geographical location of each record file.

Lastly, S106 is performed. A plurality of linking tags linking to the record files respectively are displayed on a browsing interface distributed along the traveling route. Thus, a specific record file could be opened by clicking a specific linking tag.

The record files can be shared to friends after adding some notes. It is not a practical way to share the record files by e-mail because of the limited communication bandwidth. Therefore, we could upload the record files to a far-end database for storage, the record files could be downloaded to a local computer for sharing individually.

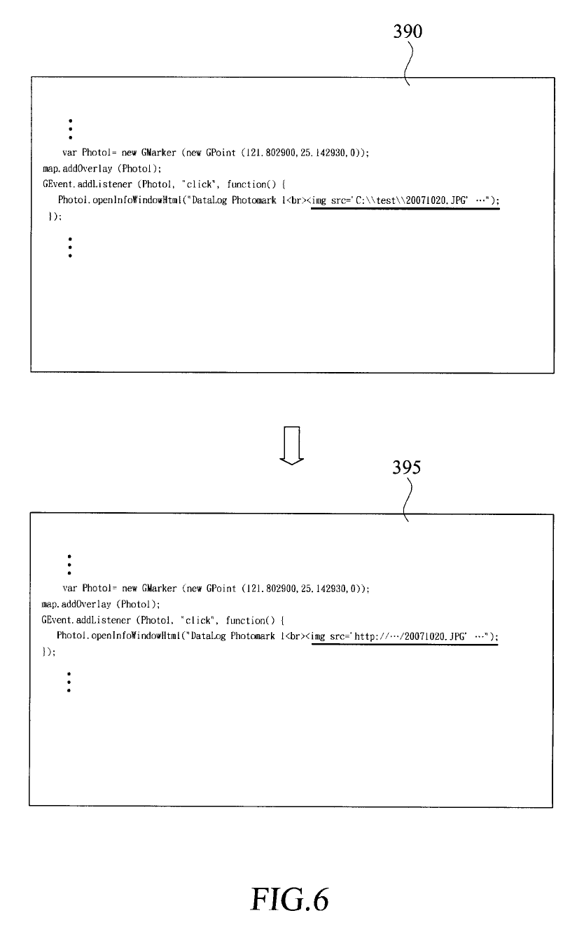

The main feature of the present invention consists is to generate a second web page used to share records by the records browsing/sharing system 10. The second web page generated by the records browsing/sharing system 10 records the far-end storage addresses of the uploaded record files rather than attaching the record files so that the data volume could be decreased. Please refer to FIG. 2 and FIG. 6. As shown in FIG. 2, the records browsing/sharing system 10 further includes a second web page developing module 120 coupled to the interface developing module 118. After uploading the record files to the far-end database, each record file is assigned to an individual far-end storage address which would be transmitted to the computer system 70. The second web page developing module 118 would obtain the far-end storage addresses corresponding to the record files. The second web page developing module 1 18 would create a second web page by copying the first web page and updating the second web page by replacing the linking address of each linking tag with the individual far-end storage address.

Please refer to FIG. 6 which shows illustrative file content of the first web page and the second web page according to the present invention. As shown in FIG. 6, in the file content of the first web page 390, the linking addresses of the record files link to the local data base individually. The second web page developing module 118 creates a second web page by copying the first web page and corrects the file content 390 to another file content 395. In the file content of the second web page 395, the linking addresses of the record files link to the far-end addresses individually. The corrected file content 395 would be saved for updating the second web page. Furthermore, the second web page developing module 118 analyzes the file content 390 by using of a keyword, such as “src”, to find out the linking addresses distributed in the file content 390 and then replaces the linking addresses of the record file with the far-end addresses.

The second web page has several control commands for performing steps of linking the map service website, downloading the map image, displaying the traveling route, and displaying the linking tags of the record files. Once the second web page is opened, a browsing interface as shown in FIG. 3 would be spread, and each linking tag links to a shared record file stored in the far-end database.

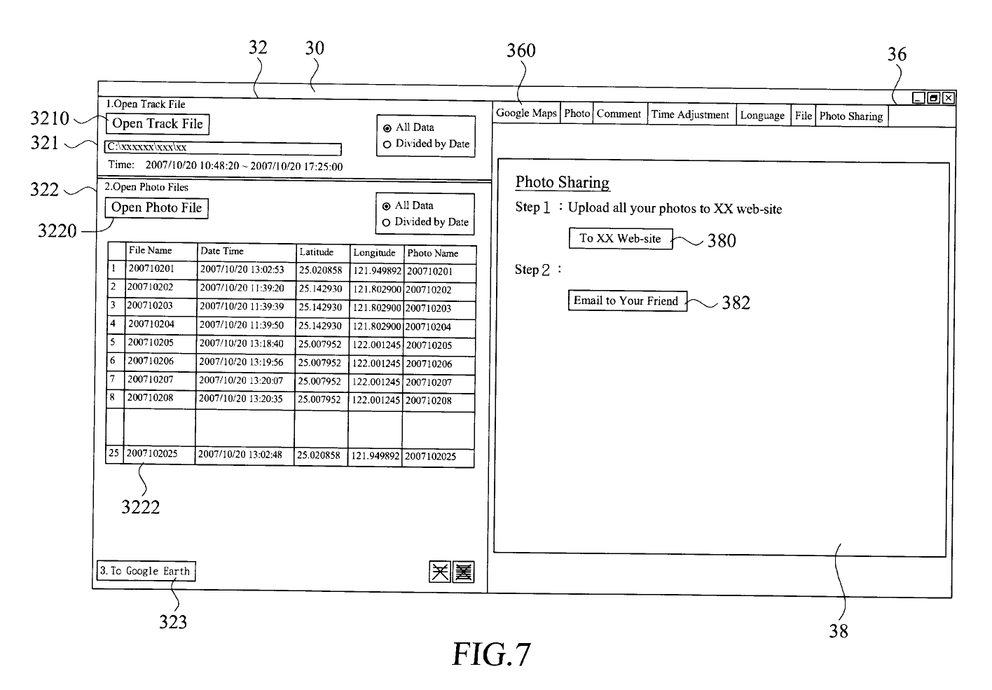

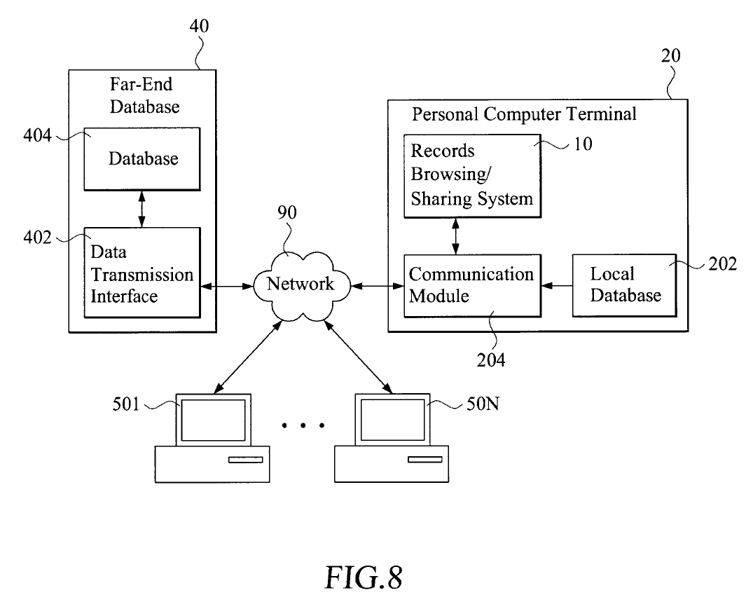

Please refer to FIG. 7 and FIG. 8. FIG. 7 shows an illustrative display of the records sharing function according to the present invention. FIG. 8 illustrates a block diagram of a communication system among personal computer terminals and a far-end database. In one embodiment, the records browsing/sharing system 10 has a records sharing function to develop a second web page used to share the record files and sending the second web page by an e-mail. As shown in FIG. 7, clicking an icon 380 would help the user to upload the record files to a far-end database. Meanwhile, the second web page would be created by the records browsing/sharing system 10. Afterwards, clicking an icon 382 would activate an e-mail software to generate a new e-mail, attach the second web page to the e-mail, and send the e-mail to friends in accordance with the chosen e-mail addresses of receivers.

The records sharing function will be illustrated in detailed with a communication system hereinafter. As shown in FIG. 8, a personal computer terminal 20 has the GPS data file and the record files stored inside. The personal computer terminal 20 includes a records browsing/sharing system 10, a local database 202 and a communication module 204. By the communication module 204, the records browsing/sharing system 10 uploads the shared record files to a far-end database 40 via the network 90. In the far-end database 40, a data transmission interface 402 would arrange the received record files stored in a database 404 and assign each record file with an individual far-end address. Then, these far-end addresses would be transmitted back to the personal computer terminal 20.

The personal computer terminal 20 could transmit the second web page to other personal computers 501˜50N via the network 90. Inside the personal computers 501˜50N, the second web page could be opened directly to display an interface for browsing the shared record files stored in the far-end database 40. The linking tags link to the far-end addresses of the shared record files stored in the database 404. When a specific linking tag is selected, a corresponding record file will be downloaded from the far-end database 40 to a personal computer. The present invention makes records sharing more conveniently and rapidly than sharing records by a web album.

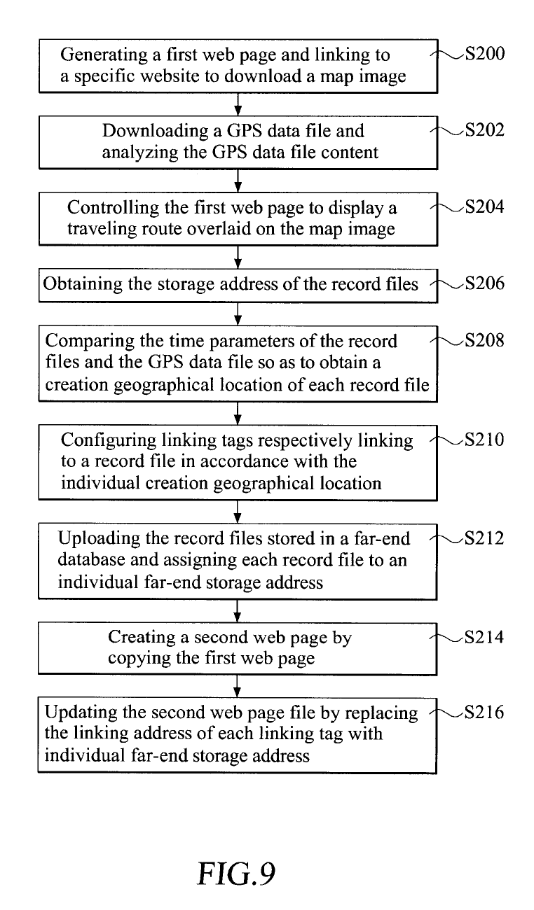

Following, a method for generating the second web page used to share records is provided. Please refer to FIG. 9 which is a flow chart of a method for generating the second web page used to share records according to the present invention. Please refer to FIG. 2 for acknowledging the block diagram. As shown in FIG. 9, the method includes the following steps.

Firstly, S200 is performed. The interface developing module 118 generates a first web page used to browse the record files, links to a specific website to download a map image and embeds the map image in the first web page.

Next, S202 is performed. The first analyzing module 112 downloads the GPS data file and analyzes the GPS data file so as to obtain the geographical locations varying with the time parameters.

Next, S204 is performed. The interface developing module 118 controls the first web page to display the traveling route on the map image according to the analysis of the GPS data file.

Next, S206 is performed. The editor 100 obtains the storage address of the record files. Each record file has an individual creation time.

Next, S208 is performed. The second analyzing module 114 analyzes the creation times of the record files and the comparing module 116 compares the creation times with the GPS data file so as to obtain a corresponding geographical location of each record file. This obtained corresponding geographical location is the creation geographical location of the record file.

Next, S210 is performed. The interface developing module 118 controls the first web page to configure linking tags linking to the record files distributed on the creation geographical locations on the map image.

Next, S212 is performed. The record files are uploaded to a far-end database and an individual far-end address is assigned to each record file.

Next, S214 is performed. A second web page developing module 120 generates a second web page by copying the first web page.

Last, S216 is performed. The second web page is updated by replacing the linking address of each record file with the individual far-end address.

In S216, the file content of second web page is analyzed for obtain the linking address of each linking tag. Then, the linking tag of each record file is replaced with the individual far-end storage address of each record file.

Therefore, through the embodiment illustrated above, one should realize that the method and system for generating the web page used to share records according to the present invention creates a web page used to share records displaying linking tags linking to the shared record file stored in a far-end database, so that the data volume is much lower than transmitting the shared record files to friends directly. The low data volume will speed up the communication. Even by wireless communication, the data transmission rate would still be high. Besides, the web page used to share records can be opened by a personal computer system directly so that the shared records browsing is much more convenient. Furthermore, browsing shared records by a personal computer rather than by a web function protects personal data security well.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for generating a web page used to share records by a computer system, comprising the steps of:
generating a first web page and embedding a map image therein; controlling the first web page to display a traveling route overlaid on the map image in accordance with a GPS data file that includes a plurality of geographical locations varying with a plurality of time parameters during moving along the traveling route;
comparing a creation time of at least one record file with the time parameters of the GPS data file so as to obtain a creation geographical location of the record file and configuring at least one linking tag having a linking address linking to the record file overlaid on the map image in accordance with the creation geographical location of the record file;
uploading the record file stored in a far-end database and assigning the record file to a far-end storage address;
creating a second web page by copying the first web page; and
updating the second web page by replacing the linking address of the linking tag with the far-end storage address of the record file.

2. The method according to claim 1, wherein the step of updating the second web page comprises the steps of:
analyzing a file content of the second web page for obtaining the linking address of each linking tag; and
replacing the linking address of the linking tag with the far-end storage address of the record file.

3. The method according to claim 2, wherein the step of obtaining the linking address of the linking tag is by using of a keyword.

4. The method according to claim 1, further comprising the step of:
analyzing the GPS data file to obtain a time parameter of each of the geographical locations.

5. The method according to claim 1, further comprising the step of:
analyzing the record file for obtaining the creation time of the record file.

6. The method according to claim 1, wherein the GPS data file is created by a GPS data recorder.

7. The method according to claim 1, wherein after the step of updating the second web page, further comprising the step of:
sending the second web page by an e-mail.

8. The method according to claim 7, wherein the step of sending the second web page comprises the steps of
generating the e-mail;
attaching the second web page to the e-mail; and
sending the e-mail.

9. The method according to claim 1, wherein the format of the the record file belongs to one selected from the group consisting of a digital image file format and a digital audio file format.

10. The method according to claim 1, wherein the map image is downloaded from a specific website.

11. A system for generating a web page used to share records by a computer system, comprising:
a first analyzing module, analyzing a GPS data file that includes a plurality of geographical locations varying with a plurality of time parameters during moving along a traveling route so as to obtain a time parameter of each of the geographical locations;
a second analyzing module, analyzing at least one record file so as to obtain a creation time of the record file;
a comparing module, coupled to the first analyzing module and the second analyzing module for obtaining a creation geographical location of the record file by comparing a creation time of the record file with the time parameters of the GPS data file;
an interface developing module, coupled to the first analyzing module and the comparing module, generating a first web page for displaying the traveling route and configuring at least one linking tag having a linking address linking to the record file in accordance with the creation geographical location of the record file; and a second web page developing module, coupled to the interface
developing module, generating a second web page by copying the first web page and replacing the linking address of the linking tag with a far-end storage address of the record file.

12. The system according to claim 11, wherein the interface developing module controls the first web page to link to a specific website to download a map image, embeds the map image in the first web page, and further overlays the traveling route and the linking tag on the map image.

13. The system according to claim 12, further comprising:
a first accessing module, coupled to the first analyzing module for accessing the GPS data file from a first storage address; and
a second accessing module, coupled to the second analyzing module for accessing the record file from a second storage address.

14. The system according to claim 13, wherein the first accessing module and the second accessing module are coupled to a local database of the computer system.

15. The system according to claim 13, further comprising an editor coupled to the first accessing module and the second accessing module, wherein the editor receives an inputted data so as to obtain the first storage address and the second storage address.

16. The system according to claim 11, wherein the GPS data file is created by a GPS data recorder.

17. The system according to claim 11, wherein the format of the at least one record file belongs to one selected from the group consisting of a digital image file format and a digital audio file format.
